(19) United States
(12) Patent Application Publication
(10) Pub. No.: US 2005/0089366 A1
(43) Pub. Date: Apr. 28, 2005

(54) Fire testing clamp and assembly

(76) Inventor: Thomas P. Naughton JR., Groton, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/694,959

(22) Filed: Oct. 28, 2003

(51) Int. Cl. F16B 1/00

(52) U.S. Cl. 403/376

(57) ABSTRACT

A clamp for use with a line burner, the clamp having an internal through-hole constructed and arranged to receive a line burner and having an external tapered surface. The tapered surface of the clamp is adapted to align or center the line burner within a hole in a unit for fire spread testing and is adapted to reduce gaps between the line burner and the hole so that flames emitted during fire spread testing from the hole are reduced or eliminated. The line burner may include an indicator constructed and arranged to assist in providing desired alignment of the gases out of the line burner during testing.

### FIELD OF INVENTION

The invention relates to a clamp. More particularly, the invention relates to a clamp for use in fire spread testing.

### BACKGROUND OF INVENTION

Numerous fire testing standards exist to test telecommunications equipment. One particular set of standards often used is the Network Equipment Building Standards (NEBS). This set of standards assures that telecommunications equipment is of a certain quality and remains functional even when catastrophic events such as extreme thermal conditions or earthquakes occur. Equipment is also tested for fire spread, but does not need to function during fire spread testing. The reliability of communications equipment is generally expected to exceed 99.999%. The NEBS standards, particularly GR-63 CORE, ANSI T1.319-2002 and GR-1089 CORE, were created to address issues of reliability of telecommunications equipment for a central office installation. Manufacturers of telecommunications equipment generally have independent laboratories test and certify that their equipment meets the NEBS. Different standards and tests are used depending on the particular technology and equipment involved.

GR-63 CORE and T1.319-2002 are particular standards under the NEBS that deals with the physical characteristics of the equipment. This standard has different tests, including tests for temperature, humidity and altitude, earthquake simulation and fire spread. The fire spread test determines how a particular unit being tested will react when a flame is introduced into the system, and it particularly tests for fire spread and fire propagation hazard of the unit.

Typically the unit to be tested is a telecom chassis having circuit cards and other components held within an outer housing. The fire spread test currently used under the GR-63 CORE standard is generally performed as follows: a circuit card is removed from the inside of the telecom chassis, a blank faceplate is placed on the housing approximate to where the circuit card was removed, and a hole having a diameter of approximately three-quarter inch is drilled into the blank faceplate. A six inch line burner is inserted through the drilled hole into the telecom chassis. The line burner simulates a circuit card on fire. Methane gas is used to light the line burner, and it is controlled to a flow profile between 0.5 to over 25 liters per minute, eventually extinguishing at about 5.5 minutes. The line burner may be lit before or after insertion into the telecom chassis.

Telecommunications equipment is expensive, and the units tested are no longer usable after testing has been performed. As such, it is important that the tests be performed properly the first time, and that the unit does not fail a test because of an error that occurs with the test itself. Improper failures, however, can occur and result in the need to repeat the test. An improper failure can drastically increase the cost of testing and certification of the equipment, as a new unit is typically needed for further testing if the initial test fails. Thus, it is desirable to perform the test correctly the first time to reduce the potential costs of testing and certification.

Different types of failures can occur with the fire spread test. For example, a test failure can occur when the flames come out the hole drilled in the unit into which the line burner is inserted or if burning occurs for longer than 30 seconds on the outside of the unit. Thus, it is important that test failures be avoided so that retesting is not required.

### SUMMARY OF INVENTION

In accordance with this invention, a line burner may be centered within a hole for fire spread testing and/or flames may be prevented from being emitted from the hole used to insert the line burner into a unit under test by providing a clamp on the line burner. This clamp may center the line burner within the hole and/or may reduce or eliminate gaps between the line burner and the hole margin to thereby reduce or eliminate flames emitted from the hole during fire testing.

In one aspect of the invention, a clamp for use in connecting a rod to a unit is disclosed. The clamp includes an outer surface, first and second ends and a through-hole provided between the first and second ends constructed and arranged to receive a rod. The clamp is adapted to substantially center the rod within a hole in a unit through which the rod is inserted.

In another aspect of the invention, a clamp for use in connecting a rod to a unit is disclosed. The clamp includes an outer surface, first and second ends and a through-hole provided between the first and second ends constructed and arranged to receive a rod. The clamp is adapted to substantially block the hole in the unit through which the rod is inserted.

In yet another aspect of the invention, a method of fire spread testing is disclosed. The method includes the steps of: providing a unit to be tested, the unit having a hole, providing a line burner for insertion through the hole into the unit, and providing a clamp having an outer surface with a tapered portion and a through-hole extending through the clamp. The line burner is slid through the through-hole of the clamp, and the clamp is secured to the line burner. The line burner is inserted through the hole in the unit to be tested at least until the tapered portion of the clamp abuts against the hole of the unit, and the line burner is ignited.

### BRIEF DESCRIPTION OF DRAWINGS

The objects, advantages and features of this invention will be more clearly appreciated from the following detailed description, when taken in conjunction with the accompanying drawings, wherein like numbers are used for like features, in which:

FIG. 1 is a perspective view of a clamp according to one embodiment of the invention;

FIG. 2A is a side view of the clamp of FIG. 1;

FIG. 2B is a side view of another embodiment of the clamp according to the invention;

FIG. 3 is an end view of the clamp of FIGS. 1 and 2A;

FIG. 4 is a perspective view of the clamp of FIG. 1 in use on a line burner; and

FIG. 5 is a perspective view of the clamp of FIG. 1 in use on a line burner that has been inserted into a unit to be tested.

### DETAILED DESCRIPTION

The present invention is directed to a clamp. The clamp may be used during fire spread testing to align a line burner within a hole in a unit to be tested. The clamp may also be used during fire spread testing to reduce or eliminate gaps between the line burner and the hole margin to reduce or prevent flames from being emitted from the hole during fire spread testing. The unit to be tested includes telecommunications equipment, such as a telecom chassis having circuit cards and other components stored within a housing.

The embodiment of the invention described below, with reference to a line burner for use in testing telecommunications equipment, particularly telecom chassis, is for illustrative purposes only. It will be understood that the various aspects of the invention are not limited to use with the particular line burner described, but instead may be used with any suitable lighting device that uses gas for ignition, such as lighters for gas grilles, stoves or furnaces. Moreover, it will be appreciated that although the clamp is described for use in performing a particular fire spread test for telecommunications equipment, the clamp may be used in connection with any fire spread test on any device, including devices other than telecommunications equipment. It will also be appreciated that the clamp is not solely for use with testing, but may be used for purposes unrelated to testing with any device to which an ignition source may be connected, for example gas grilles, stoves or furnaces. For example, the clamp could be used on lighters for gas grilles to help prevent flames from being directed back out at the operator.

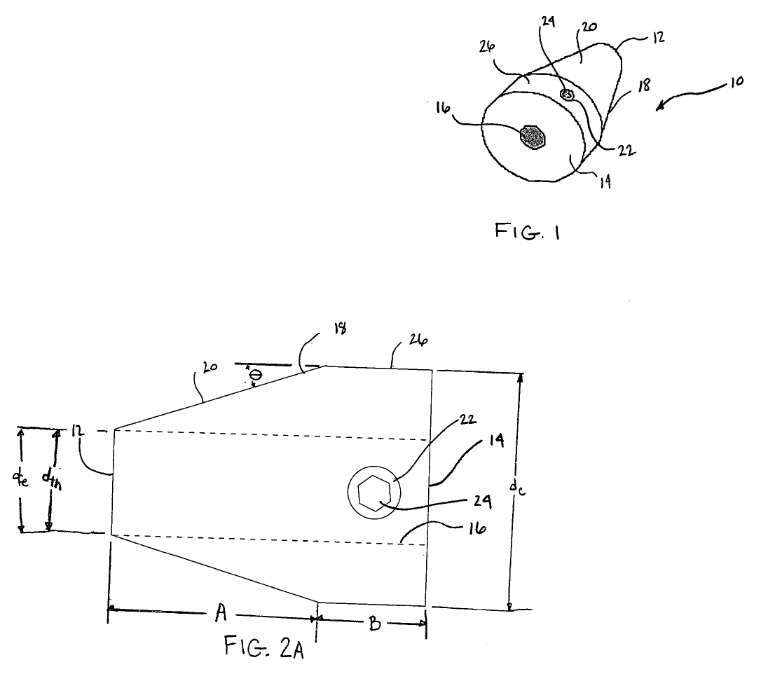

Referring now to FIGS. 1 and 2A, an illustrative embodiment of a clamp 10 according to the invention is shown. The clamp 10 has tapered and cylindrical portions 20 and 26 and first and second ends 12 and 14. A through-hole 16 extending from the first end 12 to the second end 14 is provided through the clamp 10 for receiving a rod or pipe. The through-hole 16 is illustrated as being centered within the body of the clamp 10, although it will be appreciated that the through-hole 16 may be off-set. The through-hole 16 has a diameter dₜₕ, while the clamp has a diameter d_{c} at the larger end.

The clamp 10 includes an outer sidewall 18. As illustrated in FIG. 2A, at least the portion 20 of the sidewall 18 is tapered, and more particularly is frusto-conical in shape. The smaller end of the portion 20 is provided at the first end 12 of the clamp 10. This first end 12 has a diameter d_{fe}, and this diameter d_{fe} is substantially the same as the diameter dₜₕ of the through-hole 16, as illustrated.

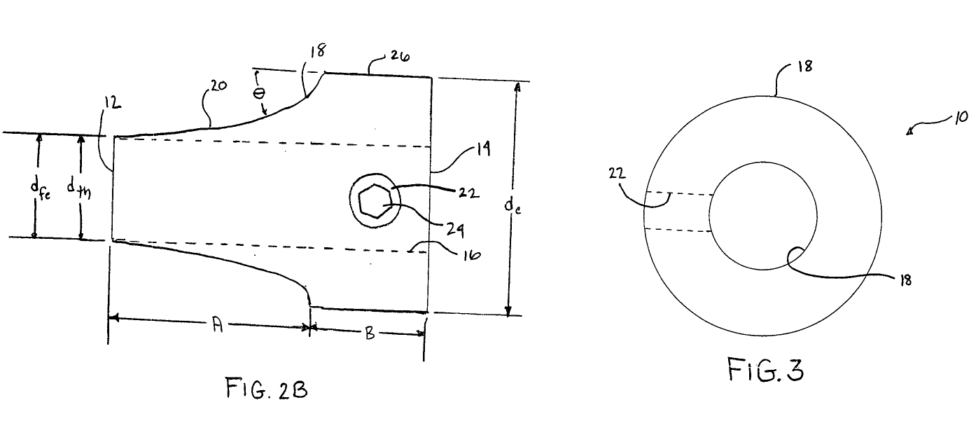

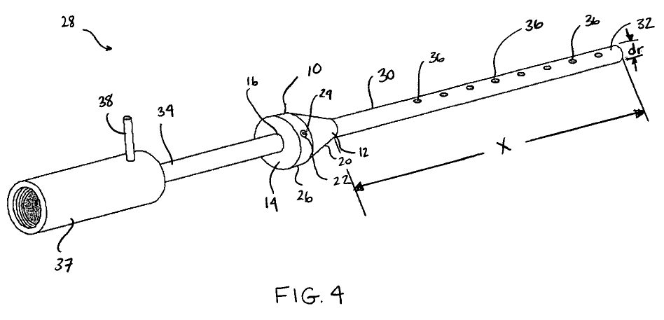

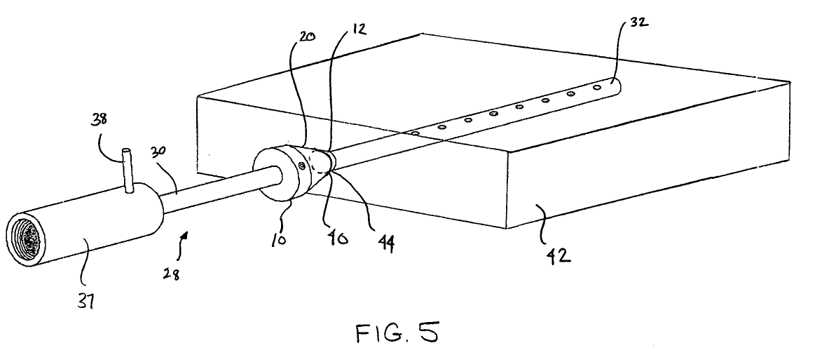

As shown in FIG. 3, an opening 22 is provided in the sidewall 18 for receiving a fastener 24 and extends perpendicular to and intersects the through-hole 16. The fastener 24 is inserted into the opening 22 to lock the clamp 10 in a desired position on a rod or pipe disposed in the through-hole 16 of the clamp 10 (see FIG. 4). Any particular fastener 24 may be used, including a thumb screw, set screw, etc. As illustrated, the opening 22 is provided on the cylindrical portion 26 of the sidewall 18, although it will be appreciated that the opening 22 may be provided in any suitable location on the clamp 10.

Referring now to FIG. 2A, the tapered portion 20 and cylindrical portion 26 of the sidewall 18 have respective lengths A and B. It will be appreciated that these portions 20 and 26 may have any particular length relative to one another. As shown, the cylindrical portion 26 has a smaller length than the tapered portion 20, but is wide enough to accommodate the opening 22. It will be appreciated that the entire sidewall 18 may be tapered with no cylindrical portion 26. The side wall of the tapered portion 20 has a frusto-conical shape that converges at an angle θ to provide the sidewall with a slope. The angle may be any suitable angle to provide a desired slope to the sidewall 18, but is preferably between 5° and 85°.

Referring now to FIG. 2B, another embodiment of the clamp 10 as shown. In this embodiment, the tapered portion 20 of the side wall 18 has a fluted shape that converges from the cylindrical portion 26 to the first end 12. In this embodiment the slope of the tapered portion 20 of the clamp 10 is varied, so that it has a radius of curvature with an angle θ that changes along the length of the sidewall 18. It will be appreciated that the tapered portion 20 may have any shape that allows the diameter dc of the clamp to converge or taper toward the diameter d_{fe} of the first end 12. The resulting diameter d_{fe} may be substantially the same size as the diameter dₜₕ of the through-hole 16. The shape of the tapered portion 20 may be any suitable shape, including frusto-conical and fluted shapes.

The clamp 10 is made of stainless steel, although any suitable material may be used, including any metals or plastics. It is preferable that the material be able to withstand higher temperatures and fire, so that during use in fire spread testing the clamp 10 will not be easily damaged. Although the clamp 10 and through-hole 16 have been illustrated and described as having circular cross-sections with diameters, it will be appreciated that either may be provided with any desired shaped cross-section to accommodate the particular shaped hole in the unit to be tested or the particular shaped rod or pipe to be inserted through the through-hole 16.

In FIG. 4, a line burner 28 is shown. The line burner 28 includes a rod 30 having first and second ends 32 and 34. The rod 30 is at least partially hollow to receive methane gas for performing the fire spread test, and a line of gas holes 36 extends from the first end 32. The holes 36 allow the methane gas and flames to escape from the rod 30. The holes 36 may be provided at any distance from one another and may be provided in any size, but are preferably provided in conformance with the desired fire spread test standard. As illustrated, the line burner 28 includes seven holes in a straight line and spaced equi-distant from one another. The first end 32 of the rod 30 is adapted for insertion through a hole 40 into a unit to be tested 42 (FIG. 5), such as the housing of a telecom chassis. The second end 34 is adapted to be connected to a gas line (not shown). A hook-up assembly 37 is provided at the second end 34 of the rod 30. The hook-up assembly 37 may be any desired mechanism to connect the line burner 28 to a gas-line.

A pin 38 extends upward from the line burner 28 adjacent where the line burner 28 is connected to the gas line. As illustrated in FIG. 4, the pin 38 is provided on the hook-up assembly 37 itself. The pin 38 indicates to a user the direction in which the line of holes 36 are facing, as the pin 38 is aligned with the line of holes 36. Thus, even when the holes 36 cannot be seen, such as when the line burner 28 is inserted into the unit to be tested, the position of the line of holes 36 may be determined. The user can then rotate the rod to move the line of holes 36 in a desired direction, such as in a direction to prevent flames from moving along cards in the unit being tested, which may avoid a test application failure. It will be appreciated that the pin 38 may be any suitable indicator provided on line burner to indicate to the user the direction in which the holes are facing, including a raised portion or a colored marker.

The clamp 10 may be slid over the first end 32 of the rod 30 by sliding the rod through the through-hole 16 to a desired position on the rod beyond the holes 36. The clamp may be placed at a distance X from the first end 32 of the rod 30. The clamp may then be secured to the rod 30 by tightening the fastener 24 in the opening 22 until the fastener 24 abuts the rod 30 and hinders sliding movement between the clamp 10 and rod 30. Hand tightening of the fastener 24 into the opening 22 until it abuts with the rod 30, is generally sufficient to keep the clamp 10 in place. The through-hole 16 and rod 30 may have substantially the same diameters dₜₕ and dᵣ, so that when the clamp 10 is secured to the rod 30 there should be substantially no relative movement between the two. The clamp 10 is placed on the rod 30 with the first end 12 of the clamp 10 (the smaller end of the tapered portion 20) facing the first end 32 of the rod 30 to be inserted into the unit to be tested.

As illustrated in FIG. 5, during use the clamp 10 is placed on the rod 30 as described above at the desired distance X from the first end 32 of rod 30 with the line of holes 36 disposed between the clamp 10 and first end 32 of the rod 30. The first end 32 of the rod 30 is then inserted into a hole 40 that has been formed in a unit 42, such as a telecom chassis, to be tested. The rod 30 is slid into the unit 42 until the tapered portion 20 abuts against the hole 40. This also aligns the line burner to a particular insertion depth within the unit 42. The first end 12 of the tapered portion 20 of the clamp 10 preferably is smaller than the hole 40 and at least a small part 44 of the clamp 10 will fit within the hole 40 in the unit 42. The part 44 of the tapered portion 20 within the hole 40 assists in centering the rod 30 within the hole 40. Additionally, the clamp 10 substantially seals or blocks the hole 40 so that flames are less likely to escape through the hole 40 during fire spread testing.

Once the line burner 28 and clamp 10 are in place and the second end 34 of the line burner 28 is connected to a gas line, the rod 30 may be rotated to align the pin 38 in the direction that the line of holes 36 are to face. The test may then be performed to the desired standards.

It will be appreciated that the angle θ of the tapered portion 20 may vary, and that the angle determines how much of the tapered portion 20 of the clamp 10 will fit within the hole 40. For example, assuming that the diameter d_{fe} of the end 12 of the clamp is constant for the same size hole 40 in the unit and the tapered portion has a frusto-conical shape with a constant slope at an angle θ, a larger angle will result in less of the portion 20 fitting within the hole 40, while a smaller angle will result in more of the portion 20 fitting within the hole 40. It will also be appreciated that the cross-section of the hole 40 and the tapered portion 20 preferably have substantially the same shape, so that a part 44 of the tapered portion 20 fits into the hole 40 substantially without gaps between the two. Thus, the amount of flames escaping from between the clamp 10 and the hole 40 is minimized.

It will also be appreciated that the tapered portion 20 may converge in any suitable manner from the cylindrical portion 26 of the clamp to the first end 12 of the clamp. Typically, the cross-section of the first end 12 is substantially the same size as the cross-section of the through-hole 16. Alternatively, the cross-section of the first end 12 may be larger than the cross-section of the through-hole 16 and still fit within the hole 40 in the unit 42. Thus, it will be appreciated that the tapered portion 20 need not taper until the cross-section of the first end 12 is substantially the same size as the cross-section of the through-hole 16.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A clamp for use in connecting a rod to a unit for use in fire spread testing of the unit, the clamp comprising:
an outer surface, first and second ends and a through-hole provided between the first and second ends constructed and arranged to receive a rod;
wherein the clamp is adapted to substantially center the rod within a hole in a unit through which the rod is inserted.

2. The clamp of claim 1, wherein the outer surface of the clamp includes a tapered portion converging toward one of the ends.

3. The clamp of claim 2, wherein the through-hole has a diameter and the tapered portion converges toward one of the ends to substantially the same diameter as the through-hole.

4. The clamp of claim 2, wherein the tapered portion of the clamp includes a frusto-conical shape.

5. The clamp of claim 2, wherein the tapered portion of the clamp has a varied angle of slope.

6. The clamp of claim 2, wherein the through-hole and tapered portion of the clamp are substantially centered with respect to one another.

7. The clamp of claim 2, wherein at least a part of the tapered portion of the clamp is adapted to fit within the hole of the unit into which the rod is inserted to substantially center the rod within the hole.

8. The clamp of claim 1, wherein the through-hole and rod have cross-sections that are substantially the same size.

9. The clamp of claim 8, wherein the hole in the unit has a cross-section that is greater than the cross-sections of the through-hole and rod.

10. The clamp of claim 9, wherein the outer surface of the clamp includes a tapered portion converging toward one of the ends, the end having a cross-section of a size between the cross-section of the hole in the unit and the cross-sections of the through-hole and rod.

11. The clamp of claim 1, further comprising:
an opening provided in the outer surface, the opening extending to and intersecting the through-hole,
wherein the clamp may be secured to the rod at a desired position by providing a fastener in the opening.

12. A clamp for use in connecting a rod to a unit for fire spread testing of the unit, the clamp comprising:
an outer surface, first and second ends and a through-hole provided between the first and second ends constructed and arranged to receive a rod;
wherein the clamp is adapted to substantially block a hole in the unit through which the rod is inserted.

13. The clamp of claim 12, wherein the outer surface of the clamp includes a tapered portion converging toward one of the ends.

14. The clamp of claim 13, wherein the through-hole has a diameter and the tapered portion converges toward one of the ends to substantially the same diameter as the through-hole.

15. The clamp of claim 13, wherein the tapered portion of the clamp includes a frusto-conical shape.

16. The clamp of claim 13, wherein the tapered portion of the clamp has a varied angle of slope.

17. The clamp of claim 13, wherein the through-hole and tapered portion of the clamp are substantially centered with respect to one another.

18. The clamp of claim 13, wherein at least a part of the tapered portion of the clamp is adapted to fit within the hole of the unit into which the rod is inserted to substantially block the hole.

19. The clamp of claim 12, wherein the through-hole and rod have cross-sections that are substantially the same size.

20. The clamp of claim 19, wherein the hole in the unit has a cross-section that is greater than the cross-sections of the through-hole and rod.

21. The clamp of claim 20, wherein the outer surface of the clamp includes a tapered portion converging toward one of the ends, the end having a cross-section of a size between the cross-section of the hole in the unit and the cross-sections of the through-hole and rod.

22. The clamp of claim 12, further comprising:
an opening provided in the outer surface, the opening extending and intersecting to the through-hole,
wherein the clamp may be secured to the rod at a desired position by providing a fastener in the opening.

23. A method of fire spread testing, the method comprising the steps of:
providing a unit to be tested, the unit having a hole;
providing a line burner for insertion through the hole into the unit;
providing a clamp having an outer surface with a tapered portion and a through-hole extending through the clamp;
sliding the line burner through the through-hole of the clamp;
securing the clamp to the line burner;
inserting the line burner through the hole in the unit to be tested at least until the tapered portion of the clamp abuts against the hole of the unit; and
igniting the line burner.

24. The method of claim 23, the step of inserting the line burner further comprising:
inserting at least a portion of the tapered portion within the hole when the tapered portion of the clamp abuts against the hole.

25. The method of claim 23, the step of inserting the line burner further comprising:
substantially centering the line burner within the hole when the tapered portion of the clamp abuts against the hole.

26. The method of claim 23, the step of inserting the line burner further comprising:
substantially blocking the hole when the tapered portion of the clamp abuts against the hole.

27. The method of claim 23, wherein the tapered portion of the clamp includes a frusto-conical shape.

28. The method of claim 23, wherein the tapered portion of the clamp has a varied angle of slope.

29. The clamp of claim 23, wherein the through-hole has a diameter and the tapered portion converges toward an end of the clamp to substantially the same diameter as the through-hole.

30. The method of claim 23, wherein the hole in the unit and the through-hole in the clamp have cross-sections, the tapered portion converging toward an end of the clamp, the end having a cross-section of a size between the cross-section of the hole in the unit and the cross-section of the through-hole.

31. The method of claim 23, wherein the through-hole of the clamp is substantially centered relative to the tapered portion of the clamp.

32. The method of claim 23, further comprising the step of:
aligning gas holes provided on the line burner to face a desired direction within the unit.

33. The method of claim 32, the step of aligning further comprising:
providing an indicator on the line burner, wherein the indicator is adapted to indicate the position of the gas holes of the line burner.

34. The method of claim 23, wherein the step of igniting occurs prior to inserting the line burner into the hole.

35. The method of claim 23, wherein the step of igniting occurs after inserting the line burner into the hole.
